(19) United States
(12) Patent Application Publication
(10) Pub. No.: US 2008/0309444 A1
(43) Pub. Date: Dec. 18, 2008

(54) Electrical Winding

(75) Inventors: Fritz Sorg, Stuttgart (DE); Volker Wandelt, Hamm (DE); Mirko Windisch, Knonau (CH)

Correspondence Address: LERNER GREENBERG STEMER LLP, P O BOX 2480, HOLLYWOOD, FL, 33022-2480, US

(73) Assignees: SIEMENS AKTIENGESELLSCHAFT, Munich (DE); STEINERT ELEKTROMAGNETBAU GMBH, Köln (DE)

(21) Appl. No.: 12/096,696

(22) PCT Filed: Dec. 5, 2006
(86) PCT No.: PCT/EP2006/069302

§ 371 Date: Jun. 9, 2008

(30) Foreign Application Priority Data
Dec. 8, 2005 (DE) 20 2005 019 390.9

(51) Int. Cl. H01F 27/28; H01B 17/00

(52) U.S. Cl. 336/180; 336/222; 174/137 R

(57) ABSTRACT

An electrical winding contains a metallic winding conductor forming individual windings. The metallic winding conductor contains a metallic conductor and an electrically insulating material surrounding the metallic conductor. An insulation inside the electrical winding can be ensured in a targeted manner by combining an electrically insulating material with a metal oxide layer surrounding the metallic winding conductor, according to the maximum electric strength required inside the electrical winding. In this way, a reduced-size electrical winding can be produced with improved heat properties. An electrical insulation of a metallic electric conductor is further described.

The invention relates to an electrical winding having a metallic winding conductor, which forms individual windings, the metallic winding conductor having a metallic conductor and an electrically insulating material surrounding the metallic conductor. Furthermore, the invention relates to an electrical insulation of a metallic, electrical conductor and to the formation of an anodized Al strip for electrical windings.

When producing an electrical winding, in particular for use as a primary—or secondary—winding in the construction of transformers, the electrical winding conductor needs to be electrically insulated. The winding conductor is wound continuously onto a support, in which case the winding conductor being wound once around the support is defined as an individual winding in the text which follows. In particular, the individual windings of the electrical winding conductor which are positioned directly after a winding need to have an electrical insulation having such an insulating effect that a dielectric breakdown between the individual windings or within the winding is prevented. The use of a metallic conductor, in particular strip aluminum, in conjunction with a layer insulation, which usually comprises plastics, (Geafol technique) is known primarily for use in the medium-voltage and high-voltage range.

One disadvantage of this technique is, however, the fact that the plastics used have poor thermal properties and therefore the electrical winding thus produced either needs to have additional cooling systems or needs to be dimensioned in structural terms to be larger than is necessary.

For example, DE 40 06 697 A1 describes a transformer which is small in size, the primary and secondary windings being wound around a core such that they cover one another and at least one of the primary and secondary windings has a sheathing conductor consisting of insulating plastic. Alternatively, the insulation can also consist of another insulating material, such as a resin, for example. For example, DE 69 629 318 T2 describes a dry, insulated transformer, whose upper-voltage winding contains an insulating sleeve consisting of thermoplastic resin, and whose lower-voltage winding is enveloped by an electrically conductive resin.

When producing electrical windings in the low voltage range, thin insulations can also be used owing to the reduced breakdown voltages. In this case, an aluminum conductor is used on whose surface an aluminum oxide layer is formed by means of anodization and provides sufficient insulation once this winding conductor produced in this way has been wound. When using high voltages and/or currents, this form of insulation is no longer sufficient, however.

One object of the present development is therefore to provide an electrical winding which ensures sufficient insulation and nevertheless has good thermally conducting properties. In this case, according to the respective requirements, operating temperatures, line losses, conductor cross sections and heat losses are intended to be reduced and therefore result in a smaller physical mass with lower weights and additional insulations.

The object is achieved according to the invention by virtue of the fact that the metallic winding conductor has a metal oxide layer, which at least partially envelops the surface of the metallic conductor. The metal oxide layer is advantageously produced by means of an electrolytic oxidation process (anodization). Alternatively, separate deposition of a metal oxide layer on the metallic conductor, such as adhesive bonding or soldering, is possible. The electrical winding according to the invention preferably consists of a strip material having an aluminum conductor, which is coated with an aluminum oxide layer.

In one preferred embodiment of the electrical winding according to the invention, depending on the maximum required dielectric strength within the electrical winding, the electrically insulating material has a variable thickness. If the thickness of the anodized layer is insufficient for insulation purposes, an additional insulation having a smaller thickness can also be introduced according to the invention, as in the case of the use of a conductor material without an anodized layer. The combination of the insulating metal oxide layer and the electrically insulating material located thereon prevents dielectric breakdown between the adjacent individual windings. The maximum dielectric strength required for this purpose varies within the electrical winding, however, in particular owing to structural and physical, for example owing to a nonlinear surge voltage distribution or thermal conditions, within the winding. Depending on these different maximum required dielectric strengths within the electrical winding, the thickness of the electrically insulating material used is likewise adapted. The greater the maximum required dielectric strength is in a specific region of the electrical winding, the greater the thickness of the insulation, for example the thickness and/or the material properties, in particular the insulating material class, of the electrically insulating material in the respective segment of the electrical winding. As a result, the physical size of the electrical winding can be reduced and, at the same time, the electrically insulating material can be used in a more targeted and therefore more cost-effective manner. Alternatively, the thickness of the metal oxide layer on the metallic conductor is varied in a manner such that, depending on the maximum required dielectric strength within the electrical winding, an insulation property continues to be provided. Depending on the structural and in particular also the physical, in particular thermal, conditions within the electrical winding, an insulation for the electrical winding which is in each case precisely suited can be provided owing to a variation in the thickness of the electrically insulating material and/or the variation in the thickness of the metal oxide layer.

In one advantageous refinement of the electrical winding according to the invention, the metal oxide layer on the metallic conductor has a constant thickness, and, depending on the maximum required dielectric strength within the electrical winding, the thickness of the electrically insulating material varies. The metal oxide layer, such as the anodized layer on an aluminum conductor, for example, has good thermal properties and therefore reduces thermal load on the electrical winding. Depending on the maximum required dielectric strength within the electrical winding, the invention provides for the electrically insulating material to have a variable thickness and/or variable material properties when an increased degree of insulation is required. For the case in which there is an increased requirement for insulation between the individual windings, the electrically insulating material is designed to be stronger and has a greater thickness and/or improved material properties, such as a higher-order insulating material classification, for example. On the other hand, in regions with a reduced requirement for insulation properties, an electrically insulating material, such as a plastic foil, for example, is selected to be correspondingly thinner and/or reduced material properties are used. These material properties of the plastic foil, such as the insulating material class on which it is based, for example, can be varied depending on the positionally dependent dielectric strength required. Depending on the maximum required dielectric strength within the electrical winding, according to the invention the thickness of the electrically insulating material may be reduced virtually to zero or even omitted completely locally, with the result that the insulating effect between the individual windings at the corresponding points is only provided owing to the metal oxide layer of the electrical winding conductor.

For the case in which certain minimum requirements for the electrical insulation are set within the electrical winding, provision is made according to the invention for the electrically insulating material to have a constant thickness and/or constant material property, in particular as regards its insulating material class, and, depending on the maximum required dielectric strength within the electrical winding, for the metal oxide layer to have a different thickness. Owing to the fact that a constant thickness and/or material properties is/are predetermined for the electrically insulating material, a minimum insulation property for the electrical winding is predetermined. Depending on the maximum required dielectric strength within the electrical winding, the metal oxide layer is adapted in terms of its thickness.

Depending on the maximum required dielectric strength within the electrical winding, the construction of the metal oxide layer advantageously varies.

In addition and/or as an alternative, a thin foil can also be introduced during the winding process. If the dielectric strength at the point subjected to the greatest load is still insufficient, a second or even third foil can be introduced (parallel) here. As a result, only two materials need to be used for the winding process: a) winding material with an anodized layer having the same thickness and b) foil having the same thickness. This does not require any adaptational work during the winding process and allows for effective use of materials.

In particular, the purity of the anodized or deposited metal oxide layer has a considerable influence on the insulation and thermal properties of the electrical winding. Primarily, impurities within the metal oxide layer result in the insulation and thermal properties being influenced. Owing to targeted use of corresponding starting and oxidation products for producing the metal oxide layer and of corresponding production methods, depending on the maximum required dielectric strength within the electrical winding, the insulation properties are influenced and are therefore transferred to the electrical winding according to the invention in optimum fashion and in a space-saving manner. In addition, depending on the maximum required dielectric strength within the electrical winding, the construction of the electrically insulating material varies.

The electrically insulating material advantageously contains enamels, plastics, in particular plastic foils, and/or paper. According to the invention, provision is likewise made for the electrically insulating material to have a stratified design. The stratified design ensures that, in the event of—even microscopically small—damage to a layer, for example a plastic foil layer, the mutually adjacent layers of the electrically insulating material ensure insulation of the electrical winding. Furthermore, the variation in the material properties of the respective plastic foil layer can be adapted, in particular depending on the dielectric strength. Only in the event of complete damage to the electrically insulating material at one point is an insulating effect of the electrically insulating material no longer provided. In addition, the metal oxide layer may have a stratified design.

One advantageous embodiment of the electrical winding is characterized by the fact that the surface of the metal oxide layer and of the electrically insulating material are constructed such that no relative displacements between the metal oxide layer and the electrically insulating material occur. The use of an, in particular roughened, surface ensures that a displacement of the electrically insulating material and of the conductor in relation to one another is ruled out during the production process and during operation, and it is therefore not necessary for there to be frequent and time-consuming monitoring of the electrical winding with respect to its insulation properties.

The object is further achieved by the features of patent claim 12. For the insulation of a metallic, electrical conductor, provision is made for the surface of the metallic, electrical conductor to be coated with a metal oxide, and for the metal oxide layer to be at least partially enveloped by an electrically insulating material. Owing to the connection between the insulation properties of the metal oxide layer and the insulation property of an electrically insulating material enveloping said metal oxide layer or an additional insulation in the form of a foil, optimum electrical insulation is ensured which can likewise vary along the metallic, electrical conductor. The electrically insulating material advantageously contains enamels, plastics, in particular plastic foil and/or paper, the electrically insulating material advantageously having a stratified design, and the electrically insulating material at least partially enveloping the metal oxide layer.

Preferred is the formation of an anodized Al strip as the electrical winding with insulating material, in particular when, as a form of a high degree of protection against breakdown between electrical windings, the value of the turn-to-turn voltage is intended to be equal to the value of the interlayer voltage.

According to the invention, the anodized Al strip as the metallic winding conductor with a metal oxide layer is first wound onto the removable support to form a coil, then a plurality of coils as segments of an entire winding with taps are arranged electrically in series, and the coils lying at the input and at the output in the entire winding are supplemented by additional layers of insulating material, which may consist of additional foil layers.

In this case, additional insulations at points are provided at the taps at the start/end of the coils or of the entire winding, in which case the additional insulations at points should likewise consist of a foil, paper or insulating enamel.

It is advantageous to provide an additional insulation such as air, a casting compound or insulating disks, for example, between the coils in order to increase the protection against axial breakdown from coil to coil in the entire winding.

Terminals consisting of a nonanodized Al strip are expediently fitted to the taps for specific applications.

Further advantageous refinements can be gleaned from the dependent claims. The subject matter of the invention will be explained in detail with reference to the figures below, in which:

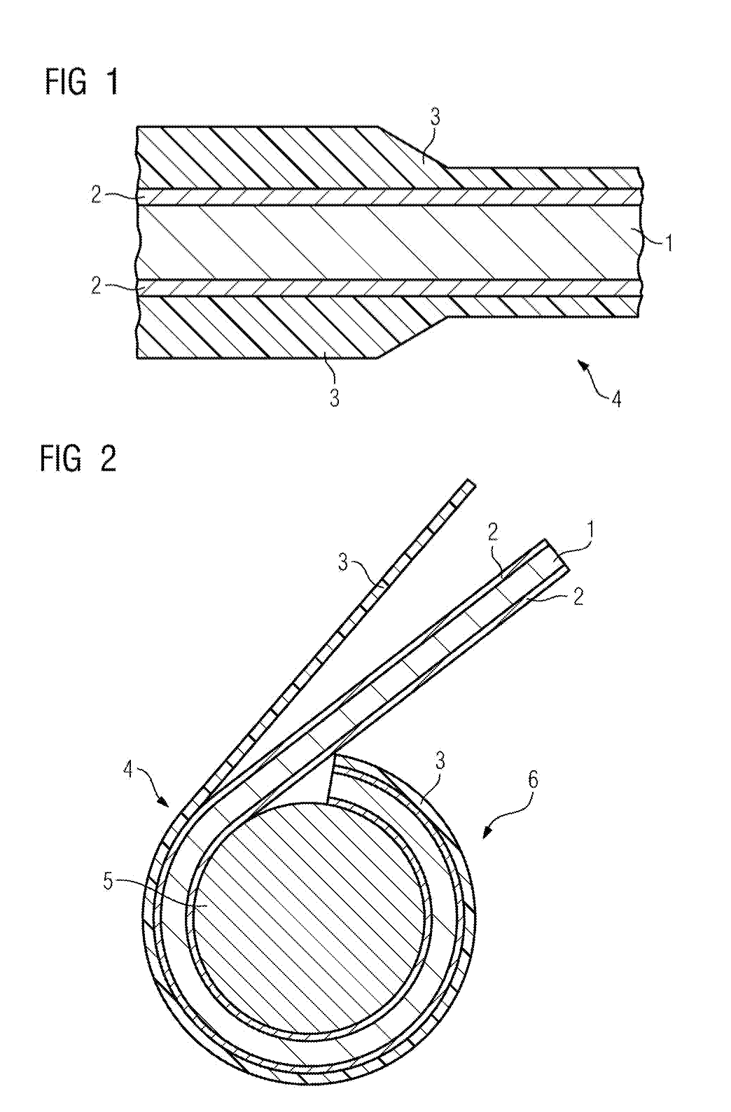

FIG. 1 shows a schematic illustration of the design of an electrical winding conductor according to the invention;

FIG. 2 shows a schematic illustration of an individual winding of the electrical winding according to the invention during the winding process;

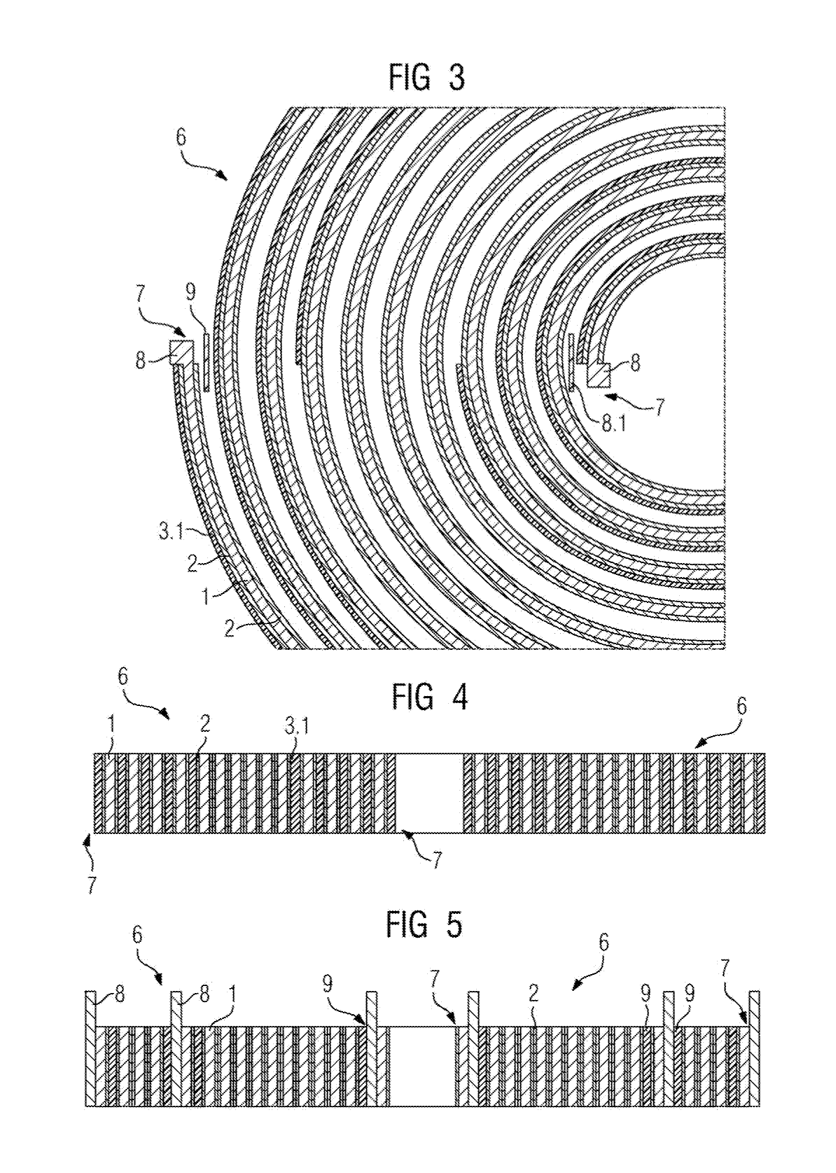

FIG. 3 shows a schematically assembled illustration of formations of an Al strip as coils (6.1) for electrical windings (6) to form an entire winding configured in segments;

FIG. 4 shows sections as shown in FIG. 3 through the entire winding; and

FIG. 5 shows sections as shown in FIG. 3 through a segment with taps (8) of the entire winding.

FIG. 1 shows a schematic illustration of the metallic winding conductor 4 according to the invention. The metallic winding conductor 4 comprises a metallic aluminum conductor 1, at least one aluminum oxide layer 2 and an electrical plastic insulating foil 3, which surrounds the metal oxide layer 2 and is positioned at least between two adjacent individual windings positioned one above the other. If segments are connected in series, only the terminating segments are provided with this additional insulation, and the segments lying therebetween are configured without additional insulation, except for the regions with taps. The electrical winding conductor 4 can in this case either be completely surrounded by a metal oxide layer 2 or alternatively a metal oxide layer 2 can be provided only at certain points on the metallic conductor 1. In the example illustrated in FIG. 1 as a sectional drawing, a metal oxide layer 2 is illustrated, on the conductor 1, as a sheathing with a constant thickness, and this metal oxide layer is surrounded by an electrically insulating material 3 having a variable thickness. The electrically insulating material 3 can in this case either be wound around the metallic conductor 1 as additional sheathing or as an intermediate layer or alternatively can be placed onto the metallic conductor 1 or onto the metal oxide layer 2 of the electrical conductor 1 only at certain points.

FIG. 2 illustrates an electrical winding 6 according to the invention, the metallic conductor 1, the metal oxide layer 2 and the electrically insulating material 3 in the form of a plastic foil being wound onto a support 5. The metal oxide layer 2 is arranged at least on the upper and lower side of the metallic conductor 1. The support 5 is preferably in the form of a cylindrical body and, within the context of the production process of the electrical winding, ensures that the electrically insulating material 3 and the metallic conductor 1 with the metal oxide layer 2 are each wound in defined paths over one another. The winding conductor 4 thus formed is wound continuously onto the support 5 during the production process. In the present example illustrated in FIG. 2, there is only an insulating effect with respect to the metal oxide layer 2 in the axial direction. In the radial direction in relation to the support 5, the plastic foil 3 as the electrically insulating material is applied as additional insulation to the respective metal oxide layer 2. As a result, depending on the maximum required dielectric strength within the electrical winding 6, complete insulation of the electrical winding 6 is ensured, and partial reinforcement of the insulation can be achieved by virtue of the fact that the metal oxide layer 2 or the insulating layer 2 are designed to be reinforced at the points which are subjected to the greatest voltage.

Specifically, FIGS. 3, 4 and 5 show, schematically, the formation of an Al strip as turns 6.1 for electrical windings 6 to form an entire winding configured in segments, as can be used in a transformer.

Merely for reasons of clarity, FIG. 3 shows the formations of the Al strip as turns 6 to form the entire winding configured in segments in schematically assembled fashion.

The Al strip forms the metallic conductor 1 and the metallic winding conductor 4 and its sheathing anodized layer forms the metal oxide layer 2. The anodized Al strip is wound onto the removable support 5 (FIG. 2) to form a coil 6.

The arrangement and connection (electrically in series) of a plurality of coils 6 as segments of the entire winding with taps 8 can be seen in FIG. 3. The coil 6 positioned at the input in the entire winding is supplemented by layers 3.1 of insulating material 3 which are additionally wound in only at the start 7, the adjoining coil 6 has only layers of the anodized Al strip as the metallic conductor 1 with the metal oxide layer 2, and the coil 6 positioned at the output in the entire winding is in turn supplemented by layers 3.1 of insulating material 3 which are additionally wound in only at the end 7 thereof.

Accordingly, FIG. 4 shows sections as shown in FIG. 3 through this entire winding and, analogously, FIG. 5 shows sections through in each case one segment with taps 8 of the entire winding, from which, in conjunction with FIG. 3, additional insulations 9 at points at the taps 8 at the start/end of the entire winding 7 can be seen. If one were to imagine the mid-axis in FIG. 5, the taps (and therefore the additional insulations) are only visible on one half of the illustration.

The additional layers 3.1 and the additional insulations 9 at points at the taps 8 at the start/end of the entire winding 7 consist of plastic foil, paper or enamel, and the terminals (not illustrated) of the taps 8 and the terminals for the winding or coil start and winding or coil end consist of a nonanodized Al strip.

1-20. (canceled)

21. An electrical winding, comprising:
a metallic winding conductor forming individual windings, said metallic winding conductor having a metallic conductor and an electrically insulating material surrounding said metallic conductor, said metallic winding conductor further having a surface and a metal oxide layer at least partially enveloping said surface of said metallic conductor.

22. The electrical winding according to claim 21, wherein said electrically insulating material has at least one of a variable thickness and variable material properties in dependence on a maximum required dielectric strength within the electrical winding.

23. The electrical winding according to claim 21, wherein said metal oxide layer has a variable thickness in dependence on a maximum required dielectric strength within the electrical winding.

24. The electrical winding according to claim 21, wherein said metal oxide layer has a constant thickness, and in that, depending on a maximum required dielectric strength within the electrical winding, said electrically insulating material has at least one of a variable thickness and variable material properties.

25. The electrical winding according to claim 24, wherein in some cases no said electrically insulating material is disposed in dependence on a maximum required dielectric strength within the electrical winding.

26. The electrical winding according to claim 21, wherein said electrically insulating material has a constant thickness and, depending on a maximum required dielectric strength within the electrical winding, said metal oxide layer has a different thickness.

27. The electrical winding according to claim 21, wherein a construction of said metal oxide layer varies in dependence on a maximum required dielectric strength within the electrical winding.

28. The electrical winding according to claim 21, wherein said electrically insulating material contains at least one of enamels, plastics, plastic foils, and paper.

29. The electrical winding according to claim 21, wherein at least one of said electrically insulating material and said metal oxide layer has a stratified design.

30. The electrical winding according to claim 21, wherein a construction of said electrically insulating material varies in dependence on a maximum required dielectric strength within the electrical winding.

31. The electrical winding according to claim 21, wherein a surface of at least one of said metal oxide layer and of said electrically insulating material are constructed such that no relative displacements between said metal oxide layer and said electrically insulating material occur.

32. An electrical insulation of a metallic, electrical conductor, the electrical insulation comprising:
a metal oxide layer coating a surface of the metallic, electrical conductor; and
an electrically insulating material at least partially enveloping said metal oxide layer.

33. The electrical insulation according to claim 32, wherein said electrically insulating material contains at least one of enamels, plastics, plastic foils, and paper.

34. The electrical insulation according to claim 32, wherein said electrically insulating material has a stratified design.

35. An electrical winding, comprising:
a plurality of anodized Al strips wound onto a removable support and forming a plurality of coils, said plurality of coils disposed electrically in series as segments forming the electrical winding, said anodized Al strips each having a metallic winding conductor and a metal oxide layer at least partially enveloping a surface of said metallic winding conductor;
taps disposed on said coils; and
an insulating material surrounding said anodized Al strips, said coils positioned at an input and at an output in the electrical winding are supplemented by additional layers of said insulating material.

36. The electrical winding according to claim 35, further comprising additional insulations disposed at points of said taps at a start/end of at least one of said coils and of the electrical winding.

37. The electrical winding according to claim 35, wherein said additional layers are additional barriers of foils disposed between said coils as axial protection against breakdown from coil to coil in the electrical winding.

38. The electrical winding according to claim 35, wherein said additional layers are formed of foils.

39. The electrical winding according to claim 36, wherein said additional insulations at said points are formed as a foil.

40. The electrical winding according to claim 35, further comprising terminals formed from a non-anodized Al strip disposed at said taps.
